(19) United States
(12) Patent Application Publication
(10) Pub. No.: US 2007/0038709 A1
(43) Pub. Date: Feb. 15, 2007

(54) Method and system for identifying spam email

(76) Inventors: Alexander Medvedev, Austin, TX (US); Rashmi Narasimhan, Austin, TX (US); Vasu Vallabhaneni, Austin, TX (US)

Correspondence Address: IBM CORP (YA);C/O YEE & ASSOCIATES PC, P.O. BOX 802333, DALLAS, TX, 75380, US

(21) Appl. No.: 11/201,647

(22) Filed: Aug. 11, 2005

(51) Int. Cl. G06F 15/16

(52) U.S. Cl. 709/206

(57) ABSTRACT

A method, system, and computer program product for selectively allowing email identified as spam by a spam filter to be received by an end-user.

### BACKGROUND

1. Technical Field of the Present Invention

The present invention generally relates to electronic mail (email), and more specifically, to methods, systems, and computer program products that assist in the identification of spam email.

2. Description of Related Art

During the infancy of the Internet, the research and education communities were responsible for defining its capabilities and protocols. Since their primary purpose was research and education, these communities did not consider it necessary to spend valuable resources on developing strong authentication protocols for communication on the Internet (i.e. they did not fully appreciate the potential commercial use). This lack of strong authentication has, unfortunately, led to every user of the Internet now being familiar with the term “spam”.

The term itself was derived from a Monty Python sketch that was set in a movie/tv studio cafeteria. During that sketch, the word “spam” slowly takes over each and every item offered on the menu until the entire dialogue was nothing more than “spam spam spam spam and spam”. This sketch so closely resembles the events that take place when mass unsolicited email posts take over emailing lists and netnews groups that the term has been pushed into common usage in the Internet community.

When unsolicited email is sent to a mailing list and/or news group it can generate more mail to the list, group, or hijacked sender from people merely responding to the email (e.g. responding to the remove me from the mailing list option) without realizing the true source/identity of the sender.

We have all become accustomed to receiving unsolicited circulars, advertisements and catalogs (“junk mail”) in the postal system, and although most of us would rather avoid them all together, the volume of these is somewhat limited by the cost the sender must bear in order to send the junk mail. Unfortunately, this type of cost impediment does not exist for spam. In fact, the only cost associated with generating the spam is its initial creation and the connectivity charge to the Internet. This is the reason why spam has become such a serious problem for everyday users.

Internet Service Providers (ISPs) have recently addressed the problem by including spam filters in their email service that create, use, and maintain blacklists (list of ISPs from which any incoming email will be discarded). Unfortunately, these blacklists can include ISPs, who are incorrectly listed, or friends who use one of the blacklisted ISPs for non-spam purposes. In example, spam and other legitimate email could be sent from an email message transfer agent that delivers mail for any sender (often referred to as an “open relay”). In response to receiving spam from the open relay, the spam filter will include the open relay on the blacklist even though the open relay also sends legitimate email.

It would, therefore, be a distinct advantage to provide the email user with the ability to selectively allow email to be received regardless of its identification by the spam filter.

### SUMMARY OF THE PRESENT INVENTION

In one aspect, the present invention is a method of identifying an email as being received from a reliable source. The method includes the step of saving identification information concerning an initial email that is transmitted. The method further includes the step of verifying that a received email is from a reliable source by matching the saved identification information with the information contained in the received email.

### BRIEF DESCRIPTION OF THE DRAWINGS

The present invention will be better understood and its numerous advantages will become more apparent to those skilled in the art by reference to the following drawings, in conjunction with the accompanying specification, in which:

FIG. 1 is a block diagram illustrating a computer system that implements a preferred embodiment of the present invention;

FIG. 2 is a diagram illustrating an example of the communication of an email using the Internet and several computer systems similar to the computer system of FIG. 1 according to the teachings of a preferred embodiment of the present invention;

FIG. 3 is a data diagram illustrating a data structure for storing information concerning an email that is sent from the sender desktop of FIG. 2 according to a preferred embodiment of the present invention;

FIG. 4 is a flow chart illustrating the processing of email to be transmitted from the sender desktop of FIG. 2 according to the teachings of the preferred embodiment of the present invention; and

FIG. 5 is a flow chart illustrating the processing of the receipt of an email sent in response to an email initially sent by an end-user of the sender desktop of FIG. 2 according to the teachings of a preferred embodiment of the present invention.

### DETAILED DESCRIPTION OF THE PREFERRED EMBODIMENT OF THE PRESENT INVENTION

The present invention is a method, system, and computer program product for providing an end-user with the ability to selectively allow email that has been identified as spam by a spam filter to be received by their mail server. The end-user sends an email (“initial email”) to a desired recipient and requests that they use the respond feature for any future emails that the recipient desires to send to the end-user (“response emails”).

The present invention saves enough information concerning the initial email so that any response emails can be recognized. Prior to discarding any email as spam, the spam filter retrieves this saved information and uses it to determine if a received email is a response email. If the received email is a response email, then the email is allowed to reach the intended recipient.

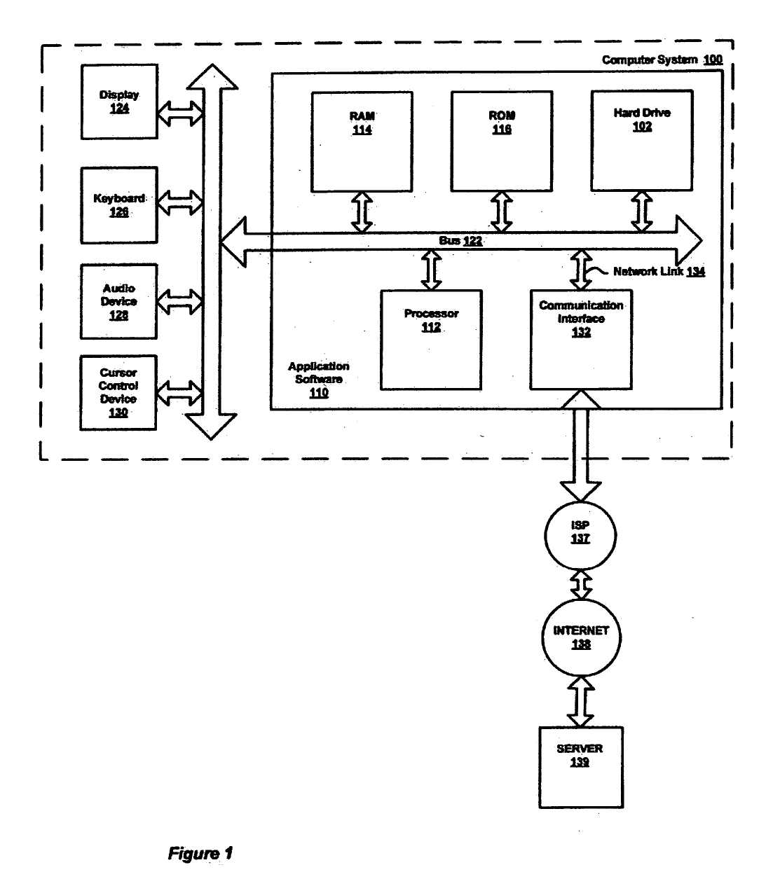

Reference now being made to FIG. 1, a block diagram is shown illustrating a computer system 100 that implements a preferred embodiment of the present invention. Computer System 100 includes various components each of which are explained in greater detail below.

Bus 122 represents any type of device capable of providing communication of information within computer system 100 (e.g., System bus, PCI bus, cross-bar switch, etc.)

Processor 112 can be a general-purpose processor (e.g., the PowerPC™ manufactured by IBM or the Pentium™ manufactured by Intel) that, during normal operation, processes data under the control of an operating system and application software 1 10 stored in a dynamic storage device such as Random Access Memory (RAM) 114 and a static storage device such as Read Only Memory (ROM) 116. The operating system preferably provides a graphical user interface (GUI) to the user.

The present invention, including the alternative preferred embodiments, can be provided as a computer program product, included on a machine-readable medium having stored on it machine executable instructions used to program computer system 100 to perform a process according to the teachings of the present invention.

The term “machine-readable medium” as used in the specification includes any medium that participates in providing instructions to processor 112 or other components of computer system 100 for execution. Such a medium can take many forms including, but not limited to, non-volatile media, and transmission media. Common forms of non-volatile media include, for example, a floppy disk, a flexible disk, a hard disk, magnetic tape, or any other magnetic medium, a Compact Disk ROM (CD-ROM), a Digital Video Disk-ROM (DVD-ROM) or any other optical medium whether static or rewriteable (e.g., CDRW and DVD RW), punch cards or any other physical medium with patterns of holes, a programmable ROM (PROM), an erasable PROM (EPROM), electrically EPROM (EEPROM), a flash memory, any other memory chip or cartridge, or any other medium from which computer system 100 can read and which is suitable for storing instructions. In the preferred embodiment, an example of a non-volatile medium is the hard drive 102.

Volatile media includes dynamic memory such as RAM 114. Transmission media includes coaxial cables, copper wire or fiber optics, including the wires that comprise the bus 122. Transmission media can also take the form of acoustic or light waves, such as those generated during radio wave or infrared data communications.

Moreover, the present invention can be downloaded as a computer program product where the program instructions can be transferred from a remote computer such as server 139 to requesting computer system 100 by way of data signals embodied in a carrier wave or other propagation medium via network link 134 (e.g., a modem or network connection) to a communications interface 132 coupled to bus 122.

Communications interface 132 provides a two-way data communications coupling to network link 134 that can be connected, for example, to a Local Area Network (LAN), Wide Area Network (WAN), or as shown, directly to an Internet Service Provider (ISP) 137. In particular, network link 134 may provide wired and/or wireless network communications to one or more networks.

ISP 137 in turn provides data communication services through the Internet 138 or other network. Internet 138 may refer to the worldwide collection of networks and gateways that use a particular protocol, such as Transmission Control Protocol (TCP) and Internet Protocol (IP), to communicate with one another. ISP 137 and Internet 138 both use electrical, electromagnetic, or optical signals that carry digital or analog data streams. The signals through the various networks and the signals on network link 134 and through communication interface 132, which carry the digital or analog data to and from computer system 100, are exemplary forms of carrier waves transporting the information.

In addition, multiple peripheral components can be added to computer system 100. For example, audio device 128 is attached to bus 122 for controlling audio output. A display 124 is also attached to bus 122 for providing visual, tactile or other graphical representation formats. Display 124 can include both non-transparent surfaces, such as monitors, and transparent surfaces, such as headset sunglasses or vehicle windshield displays.

A keyboard 126 and cursor control device 130, such as mouse, trackball, or cursor direction keys, are coupled to bus 122 as interfaces for user inputs to computer system 100.

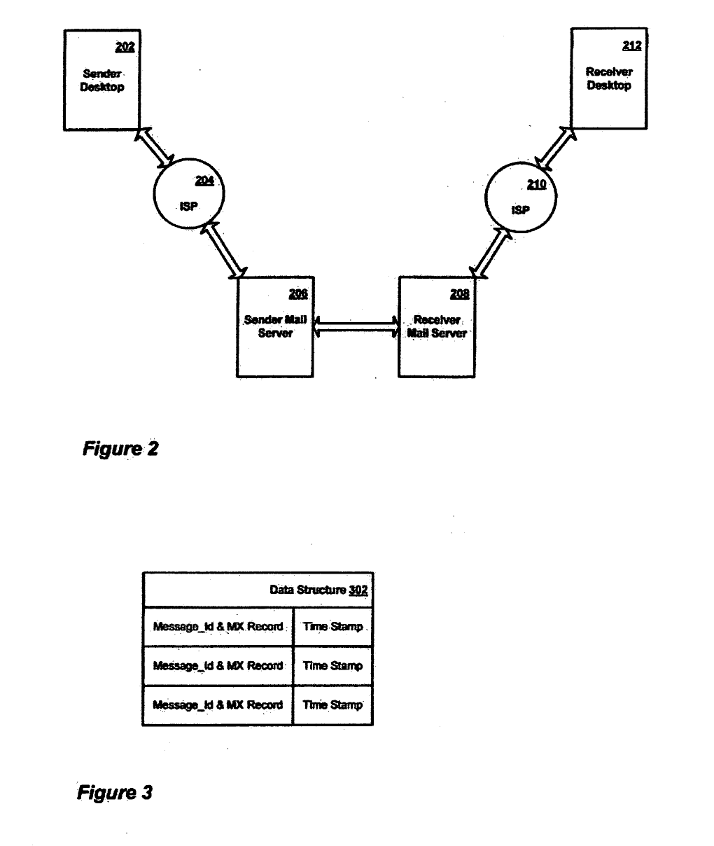

The computer system 100 can operate in the capacity of either a desktop or sever as explained in connection with FIG. 2 below.

Reference now being made to FIG. 2, a diagram is shown illustrating an example of the communication of an email using the Internet and computer systems 202, 206, 208, and 212 which are similar to the configuration and functionality of computer system 100 of FIG. 1 according to the teachings of a preferred embodiment of the present invention. In this example, the four computers (sender desktop 202, sender mail server 206, receiver mail server 208, and receiver desktop 212) are described as being involved in the transmission and receipt of an email.

In this example, it can be assumed that an end-user desires to send an email to recipient using sender desktop 202 (sender@senderdesktop.com), is connected to the Internet through an ISP 204 using a standard protocol such as TCP/IP, and composes the email using Lotus Notes™ version 6.2.

As the email travels from the sender desktop 202 to the receiver desktop 212, information concerning its creation and travel is stored in what is commonly referred to as headers attached to the email itself (Most email programs will hide these from view unless you chose to see them).

The transmission of the email from the sender desktop 202 to the sender mail server 206 generates the following header:

From: sender@senddesktop.com

To: receiver@receivedesktop.com

Date: Thurs, Jul. 14 2005 14:36:14 CST

X-Mailer: Lotus Notes v 6.12

Subject: Soccer Game

Upon receipt of the email by sender mail server 206, the following header is added.

Received: from desktopname.senddesktop.com (desktopname.senddesktop.com [124.211.3.11]) by sendermail.sendermailserver.com (8.8.5) id 004A21; Thurs, Jul. 14 2005 14:36:23—0400 (CST)

From: sender@senddesktop.com

To: receiver@receiveddesktop.com

Date: Thurs, Jul. 14 2005 14:36:23 CST

Message-Id: <sender0123456789123-12345678@sendermail.sendermailserver.com>

X-Mailer: Lotus Notes v 6.12

Subject: Soccer Game

The sender mail server 206 contacts the receiver mail server 208 and delivers the email. Upon receipt of the email by receiver mail server 208, the following header is added:

Received: from sendermail.sendermailserver.com (sendermail.sendermailserver.com [124.211.3.78]) by mailhost receiver.com (8.8.5/8.72) with ESMTPid LKJ120987 for <receiver@receiveddesktop.com>; Thurs, 14 2005 14:39:23 CST

Later, the receiver downloads the email from the receiver mail server 208 using the receiver desktop 212 via ISP 210.

The Message-Id is embedded in and will remain with this email from start to finish even when its resent using the respond feature of a standard email composer. This feature is used by the present invention as explained in connection with FIG. 3 below.

Reference now being made to FIG. 3, a data diagram is shown illustrating a data structure 302 for storing information concerning an email that is sent from the sender desktop 202 of FIG. 2 according to a preferred embodiment of the present invention. The particular format and layout of the data structure 302 is designer specific and can be numerous. In the preferred embodiment of the present invention, the data structure 302 serves the function of a cache as explained below.

The data structure 302 stores enough information concerning emails sent by the end-user (“initial email”) such that any email sent in reply (“response email”) can be identified with the initial email. In the preferred embodiment of the present invention, the Message-Id has sufficient information for this purpose and is saved each time the end-user sends an email in the data structure 302.

A time stamp identifying the time the associated initial email was sent is also stored with the message-id so that maintenance of the data structure 302 can be performed according to the desires of the end-user. Specifically, the end-user is provided with the option of having the stored message-ids expire after a certain amount of time has passed since they were stored. This can include the ability to reset the time when a response email is received using the message-id.

In an alternative preferred embodiment, the mail exchange record (MX Record) is also stored with the messageid to assist in detection of an attempted forgery of message-ids by users other than the receiver of the initial email.

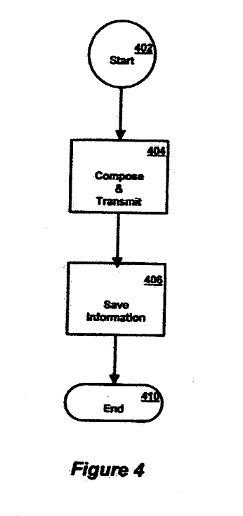

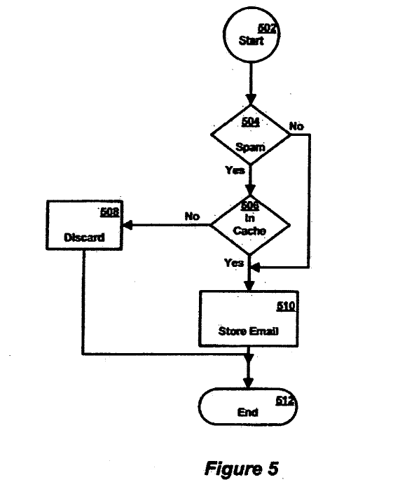

A more detailed explanation of the use of the data structure 302 is provided in connection with FIGS. 4 and 5 below.

Reference now being made to FIG. 4, a flow chart is shown illustrating the processing of an email to be transmitted from the sender desk top 202 of FIG. 2 according to the teachings of the preferred embodiment of the present invention. The process begins when and end-user composes and transmits an initial email (Steps402-404). The process continues by storing sufficient information so as to be able to identify a received email in response to the initial email (e.g. messageid) in data structure 302 (Step 408). Optionally, the MX record of the recipient can also be stored to assist in detecting forgery attempts as previously discussed. The additional processing of a transmitted email proceeds to end (Step 410). The processing of a received email is explained in connection with FIG. 5 below.

Reference now being made to FIG. 5, a flow chart is shown illustrating the processing of the receipt of an email sent in response to an email initially sent by an end-user of the sender desktop 202 of FIG. 2 according to the teachings of a preferred embodiment of the present invention. It should be noted that the processing of the received email can be performed by the sender desktop 202 or the sender mail server 206. In the preferred embodiment of the present invention, the spam filter and the processing of a received email is performed by the sender mail server 206.

The process begins upon the receipt of an email (step 502). The process continues when the execution of a spam filter or other software responsible for eliminating spam has identified the received email as spam (Step 504). The process proceeds by retrieving any information that could identify whether the received email was in response to an initial email sent by the end-user (Step 506). In the preferred embodiment, this is accomplished by searching the entries in the data structure 302 for the message_id in the received email.

If a matching entry is found, and optionally the MX records match, then the received email is stored for processing by the end-user (Steps 510 and 512). If, however, no matching entry is found, then the received email is discarded as spam (Steps 508 and 512)

It is thus believed that the operation and construction of the present invention will be apparent from the foregoing description. While the method, system, and computer program product shown and described has been characterized as being preferred, it will be readily apparent that various changes and/or modifications could be made without departing from the spirit and scope of the present invention as defined in the following claims.

What is claimed is:

1. A method of identifying an email as being received from a reliable source, the method comprising the steps of:
saving identification information concerning an initial sent email; and
verifying that a received email is from a reliable source by matching the saved identification information with the information contained in the received email.

2. The method of claim 1 wherein the identification information is created by the mail server.

3. The method of claim 1 further comprising the step of:
executing spam filter software for identifying and discarding email considered to be spam.

4. The method of claim 3 wherein the received email has been identified by the spam filter software as being considered spam, and the step of verifying includes:
verifying, prior to discarding, the received email is from a reliable source by matching the saved identification information with the information contained in the received email.

5. The method of claim 4 wherein the identification information is created by the mail server.

6. The method of claim 5 wherein the identification information is the message identification for the sent email.

7. The method of claim 6 wherein the identification information is created by the mail server that sends the initial email.

8. An apparatus for identifying an email as being received from a reliable source, the apparatus comprising:
means for saving identification information concerning an initial sent email; and
means for verifying that a received email is from a reliable source by matching the saved identification information with the information contained in the received email.

9. The apparatus of claim 8 wherein the identification information is created by the mail server.

10. The apparatus of claim 8 further comprising:
means for executing spam filter software for identifying and discarding email considered to be spam.

11. The apparatus of claim 10 wherein the received email has been identified by the spam filter software as being considered spam, and the means for verifying includes:
means for verifying, prior to discarding, the received email is from a reliable source by matching the saved identification information with the information contained in the received email.

12. The apparatus of claim 11 wherein the identification information is created by the mail server.

13. The apparatus of claim 11 wherein the identification information is the message identification for the sent email.

14. A computer program product comprising a computer useable medium having computer usable program code for identifying an email as being received from a reliable source, the computer program product including:
computer usable code for saving identification information concerning an initial sent email; and
computer usable code for verifying that a received email is from a reliable source by matching the saved identification information with the information contained in the received email.

15. The computer program product of claim 14 wherein the identification information is created by the mail server.

16. The computer program product of claim 14 further comprising:
computer usable code for executing spam filter software for identifying and discarding email considered to be span.

17. The computer program product of claim 16 wherein the received email has been identified by the spam filter software as being considered spam, and the computer usable code for verifying includes:
computer usable code for verifying, prior to discarding, the received email is from a reliable source by matching the saved identification information with the information contained in the received email.

18. The computer program product of claim 17 wherein the identification information is created by the mail server.

19. The computer program product of claim 18 wherein the identification information is the message identification for the sent email.

20. The computer program product of claim 19 wherein the identification information is created by the mail server that sends the initial email.
